(19) United States
(12) Patent Application Publication
(10) Pub. No.: US 2024/0346667 A1
(43) Pub. Date: Oct. 17, 2024

(54) CONTROL DEVICE, CONTROL METHOD, AND CONTROL PROGRAM

(71) Applicant: FUJIFILM Corporation, Tokyo (JP)

(72) Inventors: Masahiko MIYATA, Saitama-shi (JP); Kazuki INOUE, Saitama-shi (JP); Kazuki ISHIDA, Saitama-shi (JP)

(73) Assignee: FUJIFILM Corporation, Tokyo (JP)

(21) Appl. No.: 18/754,610

(22) Filed: Jun. 26, 2024

Related U.S. Application Data
(63) Continuation of application No. PCT/JP2022/046068, filed on Dec. 14, 2022.

(30) Foreign Application Priority Data
Dec. 27, 2021 (JP) 2021-212601

(51) Int. Cl. G06T 7/292

(52) U.S. Cl. CPC G06T 7/292

(57) ABSTRACT

A control device, that controls a moving object on which a projection apparatus is mounted, includes a processor, and the processor is configured to: acquire first target information related to a state of a first target; determine a projection target position and a target moving object position based on the first target information; move the moving object to the target moving object position; perform projection to the projection target position from the projection apparatus; and during moving of the moving object to the target moving object position, acquire second target information related to a state of the first target and update at least one of the projection target position or the target moving object position based on the second target information.

### CROSS REFERENCE TO RELATED APPLICATION

This is a continuation of International Application No. PCT/JP2022/046068 filed on Dec. 14, 2022, and claims priority from Japanese Patent Application No. 2021-212601 filed on Dec. 27, 2021, the entire disclosures of which are incorporated herein by reference.

### BACKGROUND OF THE INVENTION

### 1. Field of the Invention

The present invention relates to a control device, a control method, and a computer readable medium storing a control program.

### 2. Description of the Related Art

In the disclosure of JP2016-208255A, a mobile projection apparatus displays a projection image by projecting the projection image to a determined location in a state where the mobile projection apparatus is hovering. In the disclosure of JP2017-076084A, a multicopter comprises a human presence sensor and projects an image to a road surface only in a case where a person is present near the multicopter.

### SUMMARY OF THE INVENTION

One embodiment according to the disclosed technology provides a control device, a control method, and a computer readable medium storing a control program that can perform more favorable projection.

A control device according to an aspect of the present invention is a control device that controls a moving object on which a projection apparatus is mounted, the control device comprising a processor, in which the processor is configured to acquire first target information related to a state of a first target, determine a projection target position and a target moving object position based on the first target information, move the moving object to the target moving object position, perform projection to the projection target position from the projection apparatus, and during moving of the moving object to the target moving object position, acquire second target information related to the state of the first target and update the projection target position and/or the target moving object position based on the second target information.

A control method according to another aspect of the present invention is a control method performed by a processor of a control device that controls a moving object on which a projection apparatus is mounted, the control method comprising acquiring first target information related to a state of a first target, determining a projection target position and a target moving object position based on the first target information, moving the moving object to the target moving object position, performing projection to the projection target position from the projection apparatus, and acquiring, during moving of the moving object to the target moving object position, second target information related to the state of the first target and updating the projection target position and/or the target moving object position based on the second target information.

A control program stored in a computer readable medium according to still another aspect of the present invention is a control program for causing a processor of a control device that controls a moving object on which a projection apparatus is mounted, to execute a process comprising acquiring first target information related to a state of a first target, determining a projection target position and a target moving object position based on the first target information, moving the moving object to the target moving object position, performing projection to the projection target position from the projection apparatus, and acquiring, during moving of the moving object to the target moving object position, second target information related to the state of the first target and updating the projection target position and/or the target moving object position based on the second target information.

According to the present invention, a control device, a control method, and a computer readable medium storing a control program that can perform more favorable projection can be provided.

### BRIEF DESCRIPTION OF THE DRAWINGS

FIG. 1 is a diagram illustrating an example of a moving object 10 of an embodiment.

FIG. 2 is a diagram illustrating an example of a configuration of the moving object 10.

FIG. 3 is a schematic diagram illustrating an example of an internal configuration of a projection apparatus 11.

FIG. 4 is a flowchart illustrating a first example of controls of a control device 14.

FIG. 5 is a diagram (Part 1) illustrating an example of an operation of the moving object 10 under the controls of the control device 14 illustrated in FIG. 4.

FIG. 6 is a diagram (Part 2) illustrating an example of the operation of the moving object 10 under the controls of the control device 14 illustrated in FIG. 4.

FIG. 7 is a diagram (Part 3) illustrating an example of the operation of the moving object 10 under the controls of the control device 14 illustrated in FIG. 4.

FIG. 8 is a flowchart illustrating a second example of the controls of the control device 14.

FIG. 9 is a diagram illustrating an example of an update stopping area in the controls of the control device 14 illustrated in FIG. 8.

FIG. 10 is a flowchart illustrating a third example of the controls of the control device 14.

FIG. 11 is a diagram illustrating an example of an update available area in the controls of the control device 14 illustrated in FIG. 10.

FIG. 12 is a diagram illustrating an example of an imaging apparatus not mounted on the moving object 10.

FIG. 13 is a diagram illustrating an example of a circumstance in which a person 1 is seeing the moving object 10.

FIG. 14 is a flowchart illustrating a fourth example of the controls of the control device 14.

FIG. 15 is a flowchart illustrating a fifth example of the controls of the control device 14.

FIG. 16 is a diagram illustrating an example of an information terminal 110 to which the control device according to the embodiment of the present invention is applied.

FIG. 17 is a diagram illustrating an example of a hardware configuration of the information terminal 110.

### DESCRIPTION OF THE PREFERRED EMBODIMENTS

Hereinafter, an example of an embodiment of the present invention will be described with reference to the drawings.

### Embodiment

### <Moving Object 10 of Embodiment>

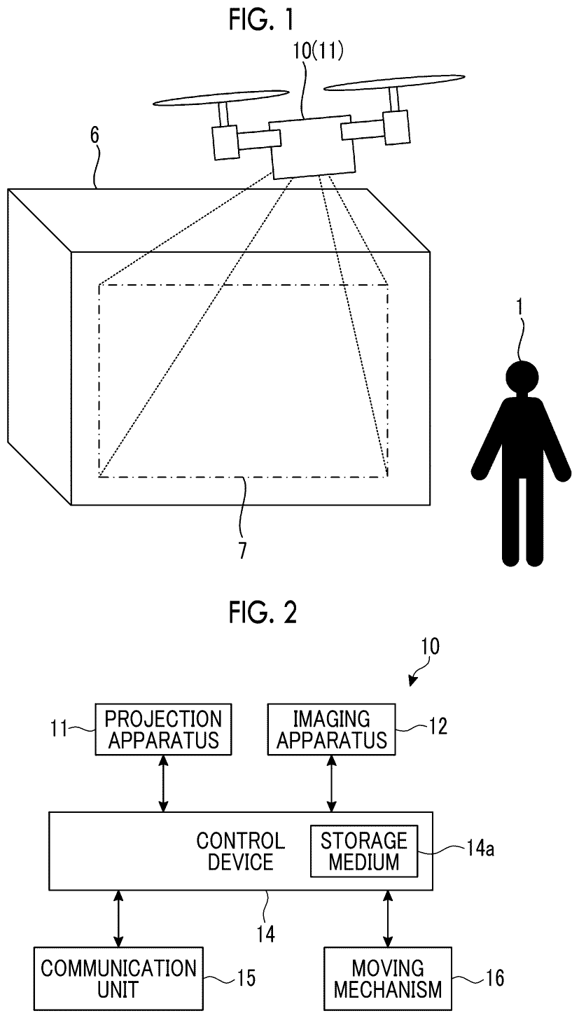

FIG. 1 is a diagram illustrating an example of a moving object 10 of the embodiment. As illustrated in FIG. 1, the moving object 10 is a movable flying object and is, for example, an unmanned aerial vehicle also referred to as a drone. For example, the moving object 10 is a multicopter including three or more rotors (for example, four rotors). A control device according to the embodiment of the present invention is mounted on, for example, the moving object 10.

A projection apparatus 11 is mounted on the moving object 10. The projection apparatus 11 is a projection apparatus that can perform projection to a projection target object 6. The projection target object 6 is an object such as a wall or a screen having a projection surface on which a projection image can be displayed by the projection apparatus 11. In the example illustrated in FIG. 1, the projection target object 6 is a rectangular cuboid.

A projection destination region 7 illustrated by a dot-dashed line is a region with which projection light is irradiated by the projection apparatus 11 on the projection target object 6. The projection destination region 7 corresponds to a part or the entirety of a projectable range to which the projection can be performed by the projection apparatus 11. In the example illustrated in FIG. 1, the projection destination region 7 has a rectangular shape.

For example, the moving object 10 projects the image to the projection destination region 7 from the mounted projection apparatus 11 while flying above a head of a person 1. The person 1 is an observer who sees the projection image projected to the projection destination region 7 by the projection apparatus 11. The person 1 is an example of a first target according to the embodiment of the present invention.

### <Configuration of Moving Object 10>

FIG. 2 is a diagram illustrating an example of a configuration of the moving object 10. As illustrated in FIG. 2, the moving object 10 comprises, for example, the projection apparatus 11, an imaging apparatus 12, a control device 14, a communication unit 15, and a moving mechanism 16.

The projection apparatus 11 is composed of, for example, a liquid crystal projector or a projector using liquid crystal on silicon (LCOS). Hereinafter, the projection apparatus 11 will be described as a liquid crystal projector.

The imaging apparatus 12 is an imaging unit including an imaging lens and an imaging element. For example, a complementary metal-oxide-semiconductor (CMOS) image sensor can be used as the imaging element.

The control device 14 is an example of the control device according to the embodiment of the present invention. The control device 14 performs various controls in the moving object 10. Examples of the controls of the control device 14 include a control of the projection performed by the projection apparatus 11, a control of imaging performed by the imaging apparatus 12, a control of communication performed by the communication unit 15, and a control of movement of the moving object 10 performed by the moving mechanism 16.

The control device 14 is a device including a control unit composed of various processors, a communication interface (not illustrated) for communicating with each unit, and a storage medium 14a such as a hard disk, a solid state drive (SSD), or a read only memory (ROM) and manages and controls the moving object 10. Examples of the various processors of the control unit of the control device 14 include a central processing unit (CPU) that is a general-purpose processor performing various types of processing by executing a program, a programmable logic device (PLD) such as a field programmable gate array (FPGA) that is a processor having a circuit configuration changeable after manufacture, or a dedicated electric circuit such as an application specific integrated circuit (ASIC) that is a processor having a circuit configuration dedicatedly designed to execute specific processing.

A structure of the various processors is more specifically an electric circuit in which circuit elements such as semiconductor elements are combined. The control unit of the control device 14 may be composed of one of the various processors or may be composed of a combination of two or more processors of the same type or different types (for example, a combination of a plurality of FPGAs or a combination of a CPU and an FPGA).

The communication unit 15 is a communication interface through which communication can be performed with other apparatuses. For example, the communication unit 15 is a wireless communication interface through which the moving object 10 performs wireless communication with an information terminal on the ground while the moving object 10 is flying.

The moving mechanism 16 is a mechanism for moving the moving object 10. For example, in a case where the moving object 10 is a multicopter, the moving mechanism 16 includes four rotors, each actuator such as a motor that rotates each of the rotors, and a control circuit that controls each actuator. However, the number of rotors or the like included in the moving mechanism 16 may be three or may be five or more.

The projection apparatus 11, the imaging apparatus 12, the control device 14, the communication unit 15, and the moving mechanism 16 are implemented as, for example, one apparatus. Alternatively, the projection apparatus 11, the imaging apparatus 12, the control device 14, the communication unit 15, and the moving mechanism 16 may be implemented by a plurality of apparatuses that can cooperate by communicating with each other.

### <Internal Configuration of Projection Apparatus 11>

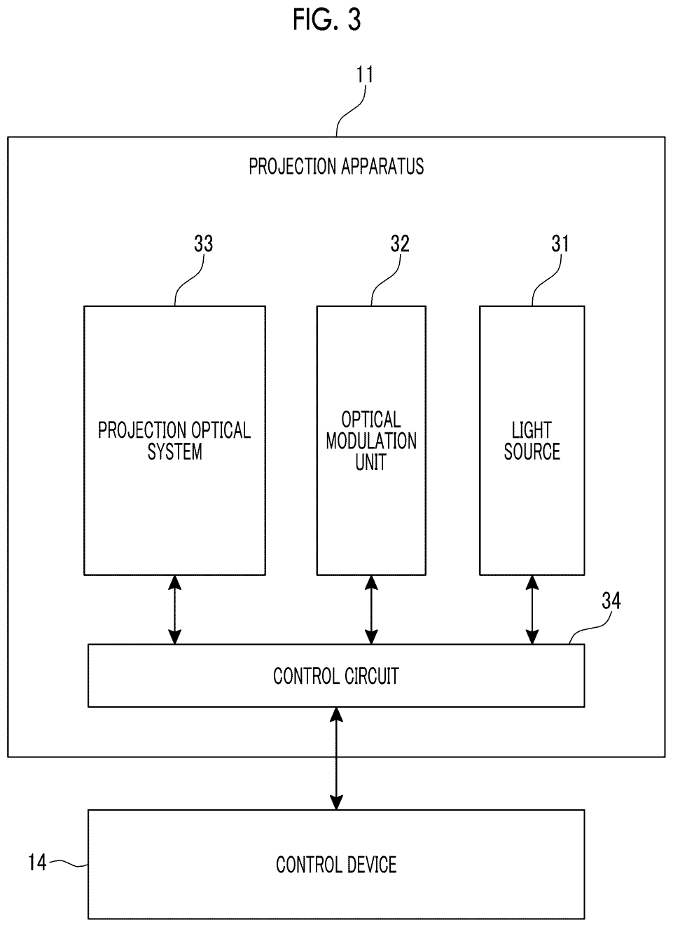

FIG. 3 is a schematic diagram illustrating an example of an internal configuration of the projection apparatus 11. The projection apparatus 11 of the moving object 10 illustrated in FIG. 2 comprises a light source 31, an optical modulation unit 32, a projection optical system 33, and a control circuit 34, as illustrated in FIG. 3. The light source 31 includes a light emitting element such as a laser or a light emitting diode (LED) and emits, for example, white light.

The optical modulation unit 32 is composed of three liquid crystal panels (optical modulation elements) that emit each color image by modulating each color light which is emitted from the light source 31 and which is separated into three colors of red, blue, and green by a color separation mechanism, not illustrated, based on image information, and a dichroic prism that mixes each color image emitted from the three liquid crystal panels and that emits the mixed color image in the same direction. Each color image may be emitted by mounting filters of red, blue, and green in the three liquid crystal panels, respectively, and modulating the white light emitted from the light source 31 using each liquid crystal panel.

The light from the light source 31 and the optical modulation unit 32 is incident on the projection optical system 33. The projection optical system 33 includes at least one lens and is composed of, for example, a relay optical system. The light that has passed through the projection optical system 33 is projected to the projection target object 6.

A region irradiated with the light transmitted through the entire range of the optical modulation unit 32 on the projection target object 6 is the projectable range to which the projection can be performed by the projection apparatus 11. A region with which the light actually transmitted from the optical modulation unit 32 is irradiated in the projectable range is a projection range (projection destination region 7) of the projection apparatus 11. For example, a size, a position, and a shape of the projection range of the projection apparatus 11 are changed in the projectable range by controlling a size, a position, and a shape of a region through which the light is transmitted in the optical modulation unit 32.

The control circuit 34 projects an image based on display data input from the control device 14 to the projection target object 6 by controlling the light source 31, the optical modulation unit 32, and the projection optical system 33 based on the display data. The display data input into the control circuit 34 is composed of three pieces of data including red display data, blue display data, and green display data.

In addition, the control circuit 34 enlarges or reduces the projection range of the projection apparatus 11 by changing the projection optical system 33 based on an instruction input from the control device 14. In addition, the control circuit 34 may move the projection range of the projection apparatus 11 by changing the projection optical system 33 based on an instruction input from the control device 14.

In addition, the projection apparatus 11 comprises a shift mechanism that mechanically or optically moves the projection range of the projection apparatus 11 while maintaining an image circle of the projection optical system 33. The image circle of the projection optical system 33 is a region in which the projection light incident on the projection optical system 33 correctly passes through the projection optical system 33 in terms of light fall-off, color separation, edge part curvature, and the like.

The shift mechanism is implemented by at least any of an optical system shift mechanism that performs optical system shifting or an electronic shift mechanism that performs electronic shifting.

The optical system shift mechanism is, for example, a mechanism that moves the projection optical system 33 in a direction perpendicular to an optical axis or a mechanism that moves the optical modulation unit 32 in the direction perpendicular to the optical axis instead of moving the projection optical system 33. In addition, the optical system shift mechanism may move the projection optical system 33 and move the optical modulation unit 32 in combination with each other.

The electronic shift mechanism is a mechanism that performs pseudo shifting of the projection range by changing a range through which the light is transmitted in the optical modulation unit 32.

In addition, the projection apparatus 11 may comprise a projection direction changing mechanism that moves the image circle of the projection optical system 33 and the projection range. The projection direction changing mechanism is a mechanism that changes a projection direction of the projection apparatus 11 by mechanically rotating to change a direction of the projection apparatus 11.

### <First Example of Controls of Control Device 14>

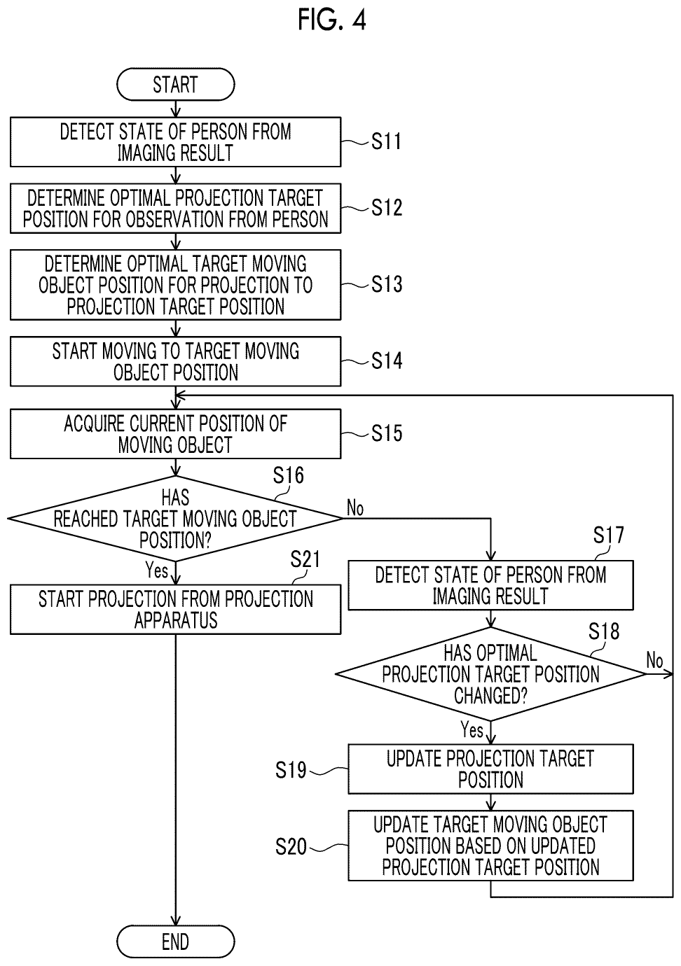

FIG. 4 is a flowchart illustrating a first example of the controls of the control device 14. The control device 14 executes, for example, processing illustrated in FIG. 4.

First, the control device 14 detects the person 1 from an imaging result of the imaging apparatus 12 and detects a state of the detected person 1 (step S11). For example, the control device 14 detects the person 1 and detects at least any of a position of eye (a direction of a visual line) of the person 1, a direction of a body of the person 1, a moving state (a speed and a direction) of the person 1, or the number of persons 1 as the state of the person 1 by performing image recognition processing based on a captured image obtained by the imaging of the imaging apparatus 12.

Next, the control device 14 determines an optimal projection target position for observation from the person 1 (step S12). Specifically, the control device 14 specifies projection candidate positions to which the projection can be performed from the imaging result of the imaging apparatus 12 and determines an optimal projection candidate position for the observation from the person 1 from the specified projection candidate positions as the projection target position. For example, the control device 14 determines a projection candidate position present in a direction in which the person 1 is seeing, a projection candidate position present in a direction in which the person 1 is facing, a projection candidate position present at a destination of moving of the person 1, or a projection candidate position present at a position easily noticeable from a plurality of persons, as the projection target position.

Next, the control device 14 determines an optimal target moving object position for the projection to the projection target position determined in step S12 (step S13). Specifically, the control device 14 specifies moving candidate positions to which the moving object 10 can move from the imaging result of the imaging apparatus 12 and determines an optimal moving candidate position for the projection to the projection target position from the specified moving candidate positions as the target moving object position. For example, the control device 14 determines a moving candidate position at which an angle of the projection with respect to the projection surface at the projection target position is the smallest among those at the moving candidate positions to which the moving object 10 can move, as the target moving object position. However, the control device 14 is not limited to the angle of the projection and may determine the target moving object position based on other factors such as whether or not an obstacle is present on an optical path of the projection light.

Next, the control device 14 starts moving the moving object 10 to the target moving object position determined in step S13 by controlling the moving mechanism 16 (step S14). Next, the control device 14 acquires a current position of the moving object 10 (step S15). For example, the control device 14 acquires the position of the moving object 10 using a global navigation satellite system (GNSS) such as a global positioning system (GPS) comprised in the moving object 10.

Next, the control device 14 determines whether or not the moving object 10 has reached the target moving object position based on the position of the moving object 10 acquired in step S15 (step S16). In a case where the moving object 10 has not reached the target moving object position (step S16: No), the control device 14 detects the state of the person 1 from the imaging result of the imaging apparatus 12 (step S17), as in step S11.

Next, the control device 14 determines whether or not the optimal projection target position has changed (step S18). For example, the control device 14 performs the determination in step S18 by selecting the optimal projection candidate position for the observation from the person 1 from the projection candidate positions to which the projection can be performed, as in step S12, and determining whether or not the selected projection candidate position has changed from the current projection target position. In a case where the optimal projection target position has not changed (step S18: No), the control device 14 returns to step S15.

In step S18, in a case where the optimal projection target position has changed (step S18: Yes), the control device 14 updates the projection target position (step S19). Specifically, the control device 14 determines the projection candidate position selected in step S18 as a new projection target position.

Next, the control device 14 determines the optimal target moving object position for the projection to the projection target position updated in step S12 (step S20) and returns to step S15. Specifically, as in step S13, the control device 14 specifies the moving candidate positions to which the moving object 10 can move from the imaging result of the imaging apparatus 12 and determines the optimal moving candidate position for the projection to the projection target position from the specified moving candidate positions as the target moving object position.

In step S16, in a case where the moving object 10 has reached the target moving object position (step S16: Yes), the control device 14 starts projecting the image to the projection target position by controlling the projection apparatus 11 (step S21) and finishes the series of processing. Accordingly, the moving object 10 transitions to a state of projecting the image to the projection target position at the target moving object position.

### <Operation of Moving Object 10 Under Controls of Control Device 14 Illustrated in FIG. 4>

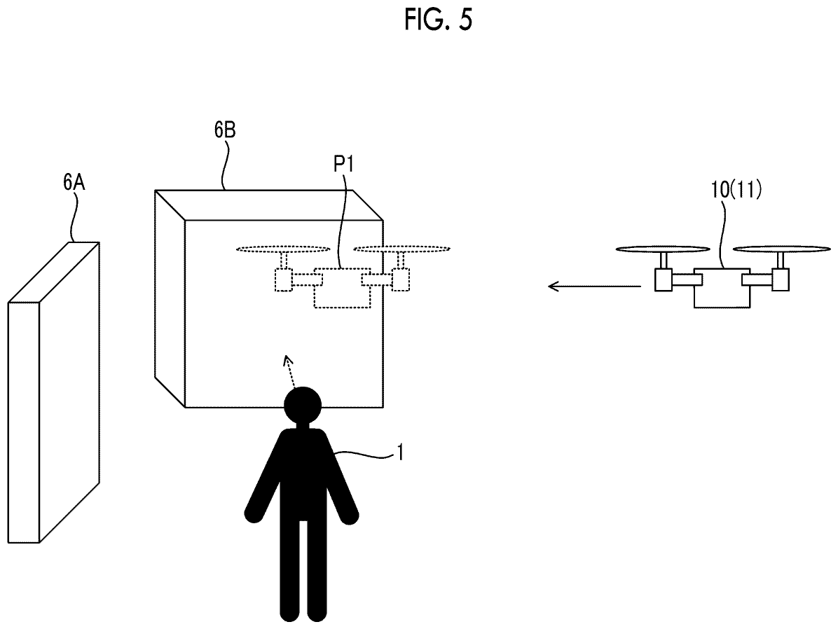

FIGS. 5 to 7 are diagrams illustrating an example of an operation of the moving object 10 under the controls of the control device 14 illustrated in FIG. 4. In FIGS. 5 to 7, a first projection target object 6A and a second projection target object 6B are objects that are positioned around the person 1 and that have a projection surface on which the projection image can be displayed by the projection apparatus 11, like the projection target object 6 illustrated in FIG. 1. In the examples in FIGS. 5 to 7, the person 1 faces in a direction of the second projection target object 6B.

First, in the state illustrated in FIG. 5, the control device 14 detects the person 1 and detects the state of the person 1 from the imaging result of the imaging apparatus 12. Here, it is assumed that the control device 14 cannot detect the person 1 facing in the direction of the second projection target object 6B because of a long distance between the moving object 10 (imaging apparatus 12) and the person 1 and consequently determines the first projection target object 6A as the optimal projection target position for the observation from the person 1. In addition, it is assumed that the control device 14 determines a first position P1 as the optimal target moving object position for the projection to the first projection target object 6A. In this case, the control device 14 starts moving the moving object 10 to the first position P1 by controlling the moving mechanism 16.

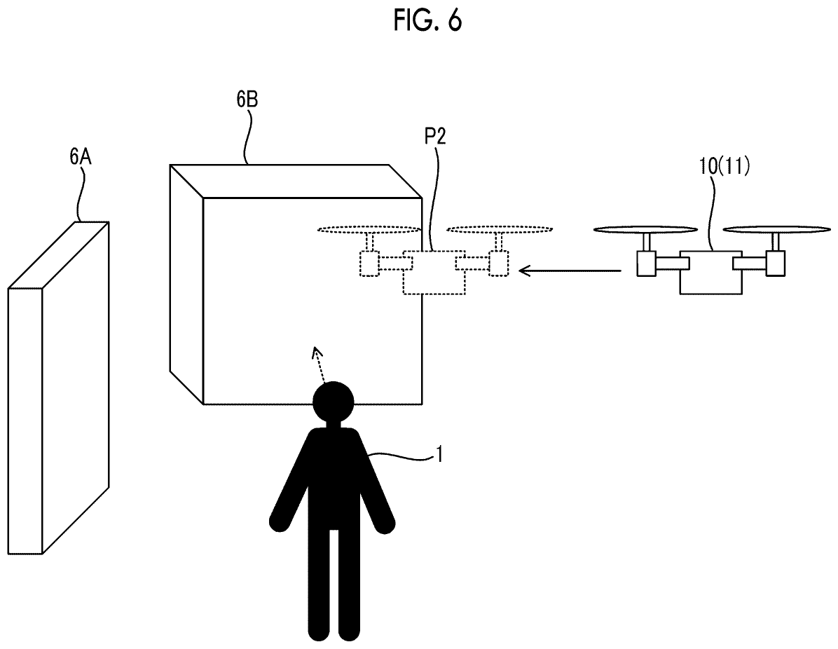

Next, the control device 14 repeats determining whether or not the optimal projection target position has changed from the imaging result of the imaging apparatus 12 until the moving object 10 reaches the first position P1. In the state illustrated in FIG. 6, it is assumed that the control device 14 detects the person 1 facing in the direction of the second projection target object 6B and consequently determines that the optimal projection target position for the observation from the person 1 is the second projection target object 6B. In this case, the control device 14 updates the projection target position to the second projection target object 6B.

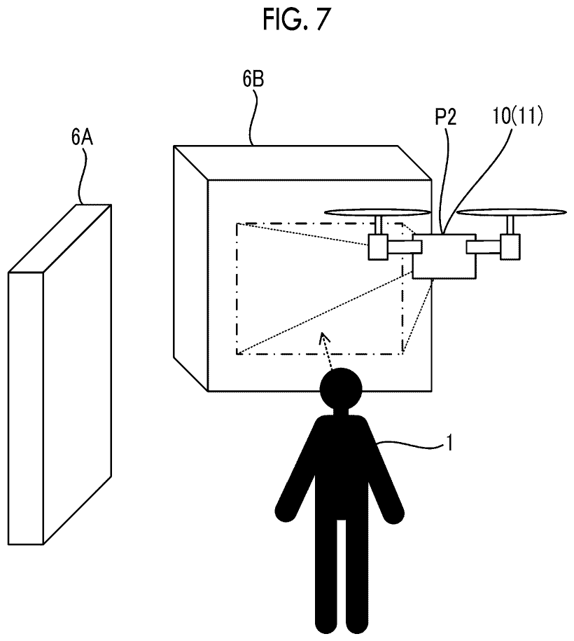

In addition, it is assumed that the control device 14 determines a second position P2 as the optimal target moving object position for the projection to the second projection target object 6B. In this case, the control device 14 changes a destination of moving of the moving object 10 to the second position P2. In a case where the moving object 10 reaches the second position P2, the control device 14 starts projecting the image to the second projection target object 6B (projection target position) from the projection apparatus 11 by controlling the moving mechanism 16, as illustrated in FIG. 7.

As described above, the control device 14 acquires a detection result (first target information) of the state of the person 1 (first target), determines the projection target position and the target moving object position based on the detection result, moves the moving object 10 to the target moving object position, and performs the projection to the projection target position from the projection apparatus 11. That is, the control device 14 performs the projection to the projection target position from the projection apparatus 11 in a state where the moving object 10 has reached the target moving object position.

Even during moving of the moving object 10 to the target moving object position, the control device 14 acquires the detection result (second target information) of the state of the person 1 and updates the projection target position and the target moving object position based on the detection result.

Accordingly, in a case where the projection target position and the target moving object position determined as being optimal have changed during moving of the moving object 10, the projection target position and the target moving object position can be flexibly updated. Examples of a case where the projection target position and the target moving object position determined as being optimal have changed during moving of the moving object 10 include a case where the optimal projection target position has changed because circumstances that could not be determined because of the long distance have been determined during moving of the moving object 10, and a case where a state of the person 1 or the projection target object has changed during moving of the moving object 10.

Accordingly, projection quality can be improved by performing the projection to a more favorable projection target position from a more favorable target moving object position, or a time required for starting the projection can be reduced by moving to the optimal target moving object position in a short time. That is, more favorable projection can be performed.

The detection result of the state of the person 1 (first target) is information obtained by imaging the person 1 via the imaging apparatus 12. While an example in which the control device 14 performs processing of detecting the state of the person 1 from the imaging result of the imaging apparatus 12 has been described above, a processor of the imaging apparatus 12 may be configured to perform the processing, or another apparatus that can communicate with the imaging apparatus 12 or with the control device 14 may be configured to perform the processing.

The optimal projection target position based on the imaging result of the imaging apparatus 12 is likely to change during moving of the moving object 10 because the imaging apparatus 12 is mounted on the moving object 10. However, according to the present embodiment, the projection target position and the target moving object position can be flexibly updated in a case where the projection target position and the target moving object position determined as being optimal based on the imaging result of the imaging apparatus 12 have changed during moving of the moving object 10. However, the present invention is not limited to the configuration in which the imaging apparatus 12 is mounted on the moving object 10. As long as the imaging apparatus 12 can communicate with the control device 14, the imaging apparatus 12 may be configured to be provided on the ground, or the imaging apparatus 12 may be configured to be provided in a moving object (for example, a flying object) different from the moving object 10.

### <Second Example of Controls of Control Device 14>

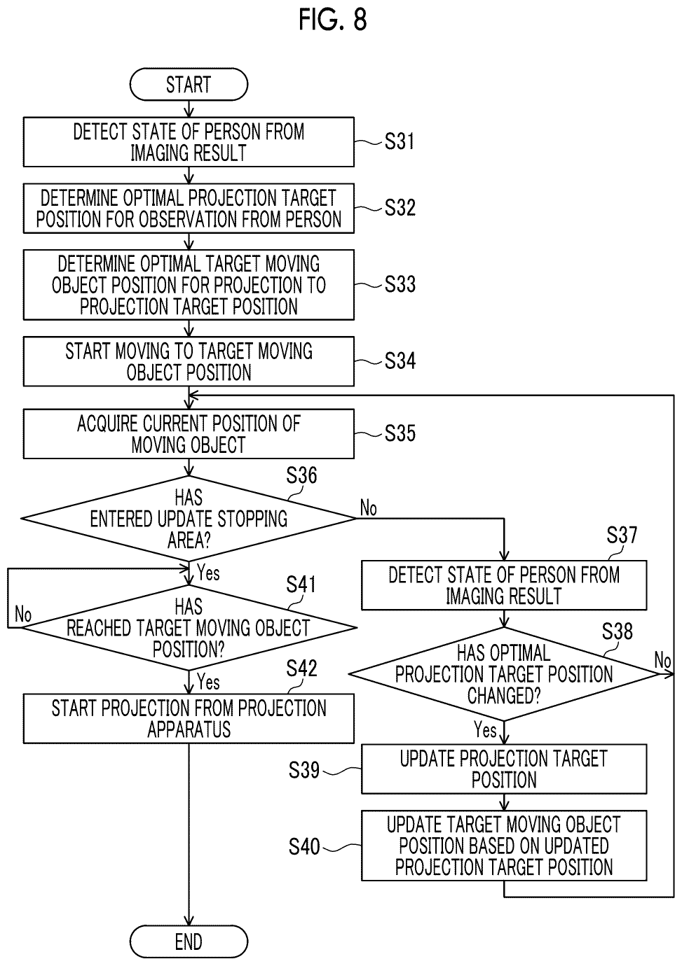

FIG. 8 is a flowchart illustrating a second example of the controls of the control device 14. The control device 14 may execute processing illustrated in FIG. 8.

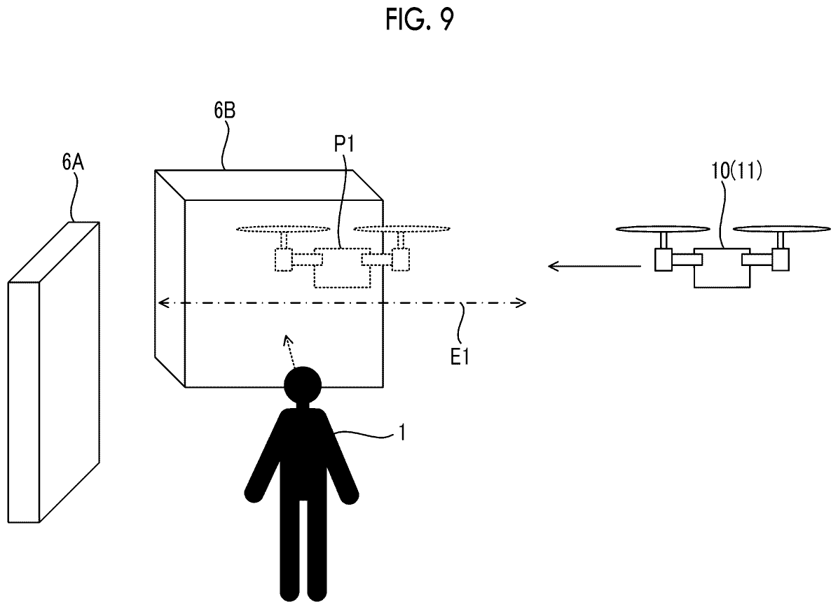

Steps S31 to S35 illustrated in FIG. 8 are the same as steps S11 to S15 illustrated in FIG. 4. After step S35, the control device 14 determines whether or not the moving object 10 has entered an update stopping area based on the position of the moving object 10 acquired in step S35 (step S36). The update stopping area is a predetermined region including the target moving object position. The update stopping area will be described using FIG. 9.

In step S36, in a case where the moving object 10 has not entered the update stopping area (step S36: No), the control device 14 transitions to step S37. Steps S37 to S40 are the same as steps S17 to S20 illustrated in FIG. 4.

In step S36, in a case where the moving object 10 has entered the update stopping area (step S36: Yes), the control device 14 determines whether or not the moving object 10 has reached the target moving object position based on the position of the moving object 10 acquired in step S35 (step S41) and waits until the moving object 10 reaches the target moving object position (step S41: No loop).

In step S41, in a case where the moving object 10 has reached the target moving object position (step S41: Yes), the control device 14 performs the control of starting projecting the image to the projection target position from the projection apparatus 11 (step S42) and finishes the series of processing.

### <Update Stopping Area in Controls of Control Device 14 Illustrated in FIG. 8>

FIG. 9 is a diagram illustrating an example of the update stopping area in the controls of the control device 14 illustrated in FIG. 8. The same parts as the parts illustrated in FIG. 5 will be designated by the same reference numerals in FIG. 9 and will not be described. In the state in FIG. 9, it is assumed that the target moving object position is the first position P1. In a case where the moving object 10 enters the update stopping area E1 during moving of the moving object 10 to the target moving object position (first position P1), the control device 14 stops updating the projection target position and the target moving object position.

In FIG. 9, an update stopping area E1 is a region of which a distance from the target moving object position (first position P1) in a moving direction of the moving object 10 is less than or equal to a predetermined distance. That is, in a case where a distance between the moving object 10 and the target moving object position is less than or equal to the predetermined distance, the control device 14 stops updating the projection target position and the target moving object position.

Accordingly, changes in the projection target position and the target moving object position in a stage where the moving object 10 has approached the target moving object position can be avoided, and frequent changes in moving of the moving object 10 can be prevented. The update stopping area E1 is not limited to the example illustrated in FIG. 9 and may be a spherical region centered at the target moving object position, a circular region or an ellipse centered at the target moving object position in a horizontal direction, or regions having other shapes. In addition, the update stopping area E1 may be a region centered at a position shifted from the target moving object position (for example, a position shifted in a direction of the moving object 10).

### <Third Example of Controls of Control Device 14>

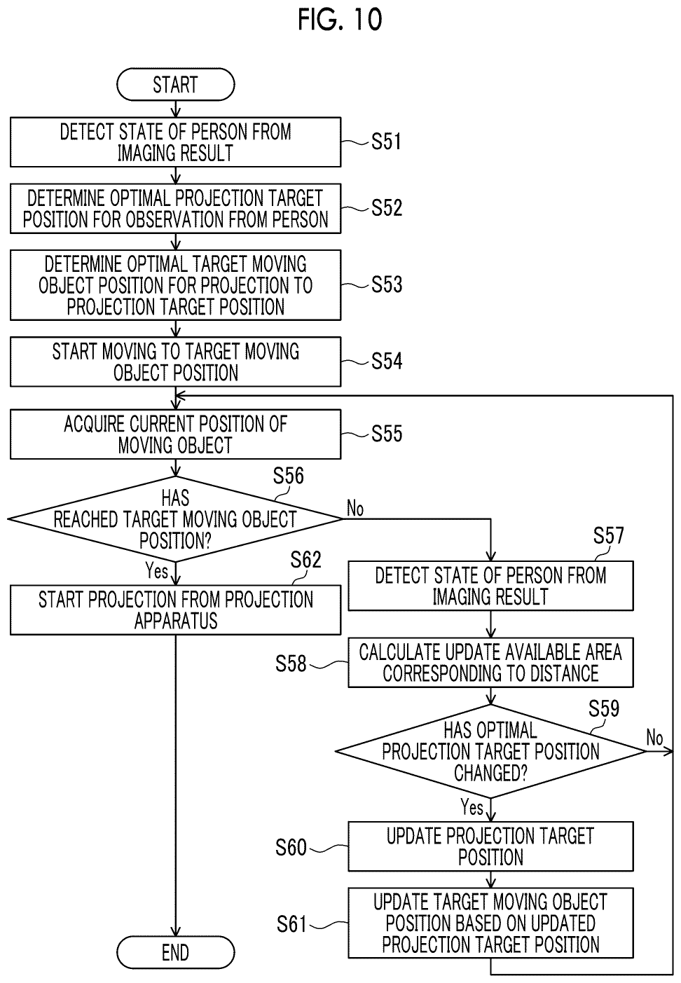

FIG. 10 is a flowchart illustrating a third example of the controls of the control device 14. The control device 14 may execute processing illustrated in FIG. 10.

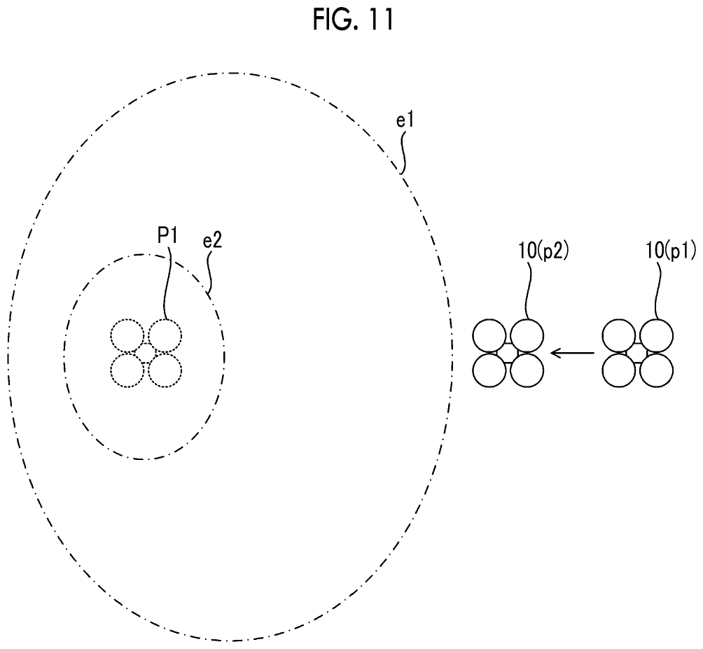

Steps S51 to S57 illustrated in FIG. 10 are the same as steps S11 to S17 illustrated in FIG. 4. After step S57, the control device 14 calculates an update available area corresponding to the distance between the moving object 10 and the target moving object position (step S58). The calculation of the update available area corresponding to the distance between the moving object 10 and the target moving object position will be described using FIG. 11.

Steps S59 to S62 illustrated in FIG. 10 are the same as steps S18 to S21 illustrated in FIG. 4. However, in step S59, the control device 14 selects the optimal projection candidate position for the observation from the person 1 from the projection candidate positions included in the update available area calculated in step S58 among the projection candidate positions to which the projection can be performed. The control device 14 determines whether or not the optimal projection target position has changed by determining whether or not the selected projection candidate position has changed from the current projection target position.

### <Update Available Area in Controls of Control Device 14 Illustrated in FIG. 10>

FIG. 11 is a diagram illustrating an example of the update available area in the controls of the control device 14 illustrated in FIG. 10. FIG. 11 illustrates a state where the moving object 10 is seen in a vertical direction from above the moving object 10. In the state in FIG. 11, it is assumed that the target moving object position is the first position P1.

A first update available area e1 is the update available area calculated when the moving object 10 is positioned at a first position p1. A second update available area e2 is the update available area calculated when the moving object 10 is positioned at a second position p2. The second position p2 is a position closer to the first position P1 than the first position p1.

While both of the first update available area e1 and the second update available area e2 are regions including the first position P1 (target moving object position), the second update available area e2 is a region narrower than the first update available area e1. In addition, in FIG. 11, both of the first update available area e1 and the second update available area e2 are elliptical regions in the horizontal direction.

As described above, the control device 14 sets the update available area to be narrower as the distance between the moving object 10 and the target moving object position is decreased. Accordingly, as the moving object 10 approaches the target moving object position, significant changes in the projection target position and the target moving object position are suppressed, and frequent changes in moving of the moving object 10 can be prevented. The first update available area e1 and the second update available area e2 are not limited to the example illustrated in FIG. 11 and can have various shapes.

In addition, the first update available area e1 and the second update available area e2 may be regions centered at the target moving object position or may be regions centered at a position shifted from the target moving object position (for example, a position shifted in the direction of the moving object 10).

### <Imaging Apparatus Not Mounted on Moving Object 10>

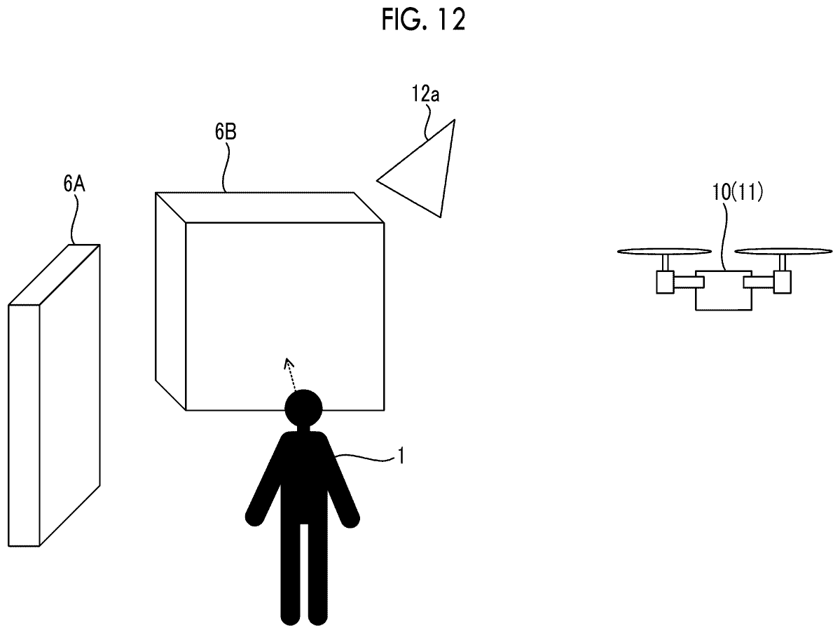

FIG. 12 is a diagram illustrating an example of an imaging apparatus not mounted on the moving object 10. For example, the control device 14 may be able to communicate with an imaging apparatus 12a not mounted on the moving object 10. The imaging apparatus 12a, for example, may be installed close to the projection target object 6 on the ground or may be mounted on a moving object (for example, another flying object) different from the moving object 10.

In this case, the control device 14 may receive a captured image obtained by imaging of the imaging apparatus 12a from the imaging apparatus 12a and acquire the first target information related to the state of the person 1 (first target) based on both of the imaging result of the imaging apparatus 12 mounted on the moving object 10 and an imaging result of the imaging apparatus 12a.

### <Circumstance in Which Person 1 is Seeing Moving Object 10>

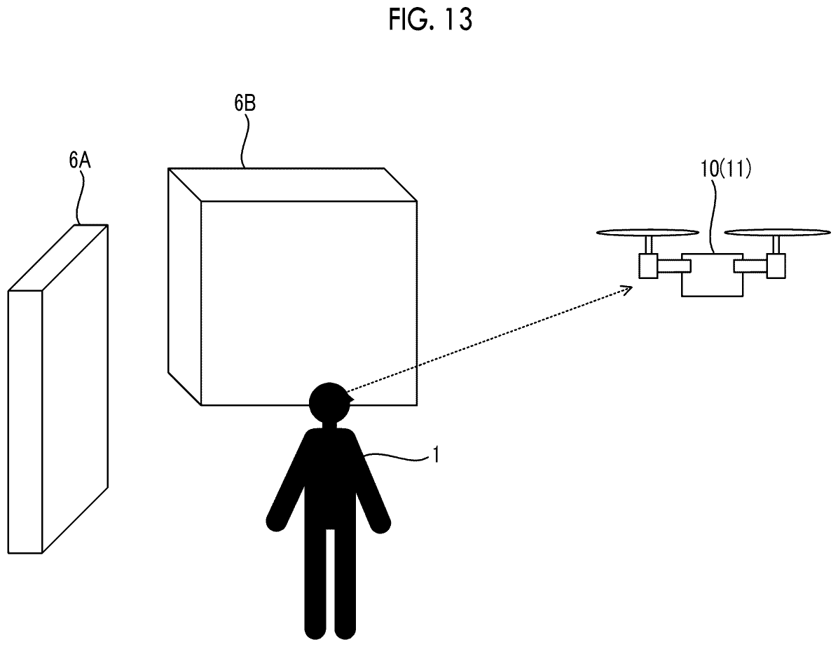

FIG. 13 is a diagram illustrating an example of a circumstance in which the person 1 is seeing the moving object 10. The same parts as the parts illustrated in FIG. 5 will be designated by the same reference numerals in FIG. 13 and will not be described. In the example illustrated in FIG. 13, the person 1 notices the flying moving object 10 and is looking up at the moving object 10. The control device 14 detects a state where the person 1 is seeing the moving object 10 based on, for example, the imaging result of the imaging apparatus 12. For example, the control device 14 detects the state where the person 1 is seeing the moving object 10 by detecting a direction of a face or the direction of the visual line of the person 1 using the image recognition processing based on the captured image obtained by the imaging apparatus 12.

In a case where the state where the person 1 is seeing the moving object 10 is detected, the control device 14 determines or updates the projection target position by excluding the state of the person 1 detected in the state. For example, in a case where the state where the person 1 is seeing the moving object 10 is detected, the control device 14 determines or updates the projection target position by assuming that the state of the person 1 detected immediately before detecting the state where the person 1 is seeing the moving object 10 continues.

As described above, the control device 14 may determine the projection target position by excluding a change in the detection result (first target information) of the state of the person 1 caused by the moving object 10. Accordingly, a more appropriate projection target position and a more appropriate target moving object position can be accurately selected.

### <Fourth Example of Controls of Control Device 14>

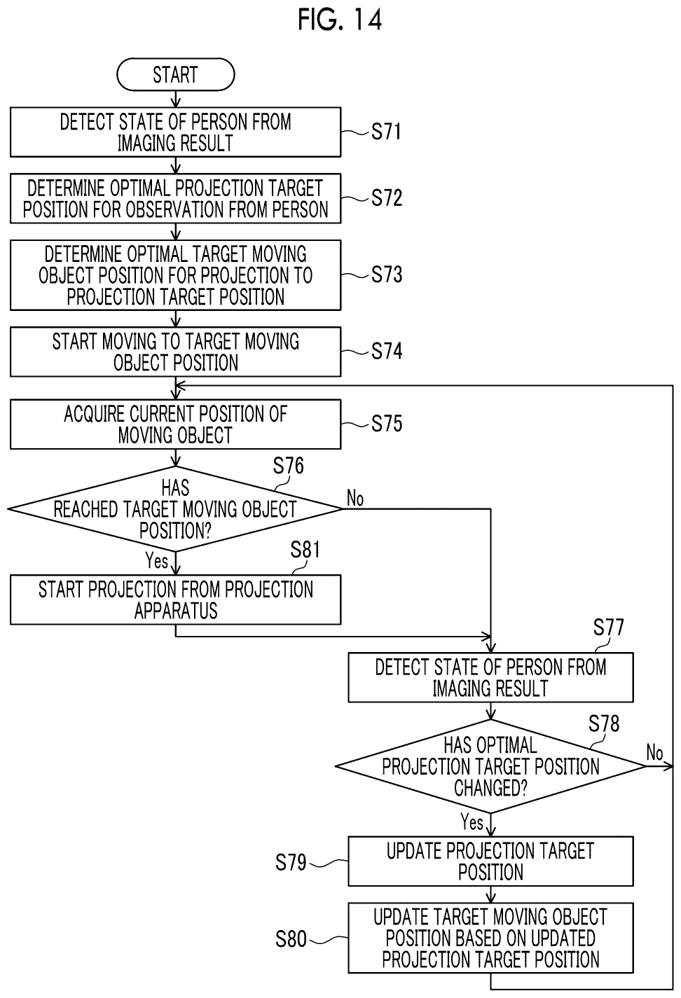

FIG. 14 is a flowchart illustrating a fourth example of the controls of the control device 14. The control device 14 may execute processing illustrated in FIG. 14.

Steps S71 to S81 illustrated in FIG. 14 are the same as steps S11 to S21 illustrated in FIG. 4. However, after the control of starting projecting the image to the projection target position from the projection apparatus 11 is performed in step S81, the control device 14 transitions to step S77.

That is, even after the moving object 10 reaches the target moving object position and the projection of the image to the projection target position from the projection apparatus 11 is started, the control device 14 continues acquiring the state of the person 1 (second target information) based on the imaging result of the imaging apparatus 12 and updating the projection target position and the target moving object position based on the acquired state of the person 1. In a case where the target moving object position is updated, the moving object 10 transitions to a state where the moving object 10 has not reached the target moving object position. Thus, the moving object 10 moves to the updated target moving object position again.

Accordingly, in a case where the moving object 10 reaches the target moving object position, the projection of the image to the projection target position from the projection apparatus 11 is started, and then the projection target position and the target moving object position determined as being optimal have changed, the projection target position and the target moving object position can be flexibly updated.

### <Fifth Example of Controls of Control Device 14>

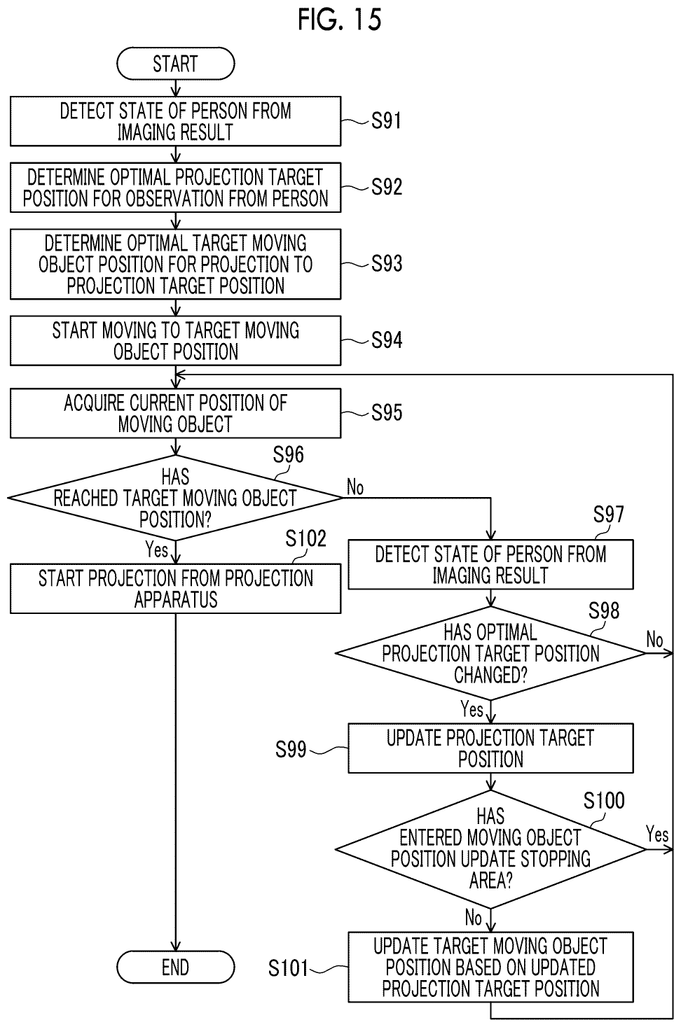

FIG. 15 is a flowchart illustrating a fifth example of the controls of the control device 14. The control device 14 may execute processing illustrated in FIG. 15.

Steps S91 to S99 illustrated in FIG. 15 are the same as steps S11 to S19 illustrated in FIG. 4. After step S99, the control device 14 determines whether or not the moving object 10 has entered a moving object position update stopping area based on the position of the moving object 10 acquired in step S35 (step S100). The moving object position update stopping area is the same region as the update stopping area described using FIGS. 8 and 9. However, the moving object position update stopping area is a region in which the update of the projection target position is not stopped while the update of the target moving object position is stopped.

In step S100, in a case where the moving object 10 has not entered the moving object position update stopping area (step S100: No), the control device 14 transitions to step S101 and updates the target moving object position. Steps S101 and S102 illustrated in FIG. 15 are the same as steps S20 and S21 illustrated in FIG. 4. In a case where the moving object 10 has entered the moving object position update stopping area (step S100: Yes), the control device 14 maintains the target moving object position and returns to step S95.

As described above, in a case where the moving object 10 is positioned in the moving object position update stopping area (predetermined region) including the target moving object position and the projection target position is updated, the control device 14 may maintain the target moving object position. Accordingly, in a case where the optimal target moving object position has changed in a stage where the moving object 10 has approached the target moving object position to a certain degree, the projection target position can be changed by changing only the projection direction and maintaining the target moving object position. Accordingly, an increase in a moving time of the moving object 10 caused by the update of the projection target position and an increase in the time required for starting the projection can be suppressed.

### <Case Where First Target Corresponds to Plurality of Persons>

While a case where the first target is the person 1 has been described, the first target may correspond to a plurality of persons. For example, in a case where a plurality of persons are detected from the imaging result of the imaging apparatus 12, the control device 14 acquires the first target information indicating states of the plurality of persons and determines the projection target position and the target moving object position based on the acquired first target information. For example, the first target information in this case is at least any of positions of eyes (directions of visual lines) of the plurality of persons, directions of bodies of the plurality of persons, a positional relationship among the plurality of persons, and moving states of the plurality of persons.

For example, the control device 14 calculates an evaluation value of easiness of observation from the plurality of persons for each of the projection candidate positions to which the projection can be performed and determines a projection candidate position having the highest calculated evaluation value as the projection target position. For example, in a case where it is assumed that the plurality of persons are two persons including a first person and a second person, the evaluation value of the easiness of the observation from the plurality of persons can be a representative value (for example, a total, an average, or a minimum value) of an evaluation of easiness of observation from the first person and an evaluation value of easiness of observation from the second person. The average may be a weighted average.

### <Case Where First Target is Automobile or Like>

While a case where the first target is the person 1 has been described, the first target may be an object other than a person. For example, the first target may be an automobile in which a person is riding. For example, in a case where the person riding in the automobile observes the projection image through a windshield, there is a high probability that the projection target object present in a direction of a front of the automobile is the optimal projection target position. In this case, the control device 14 acquires, for example, a detection result of a direction of the automobile as a detection result of a state of the automobile (first target).

### <Case Where First Target is Projection Destination Object>

The first target is not limited to an observer of the projection, an automobile in which the observer of the projection is present, or the like and may be a projection destination object that is a candidate of the projection target position. For example, the control device 14 may acquire projection surface information related to a state of a projection surface of the projection destination object (for example, whether or not the projection destination object has a surface suitable for the projection) as the first target information.

In this case, the control device 14 acquires a detection result (first target information) of a state of the projection destination object (first target), determines the projection target position and the target moving object position based on the detection result, moves the moving object 10 to the target moving object position, and performs the projection to the projection target position from the projection apparatus 11. Even during moving of the moving object 10 to the target moving object position, the control device 14 acquires the detection result (second target information) of the state of the projection destination object and updates the projection target position and the target moving object position based on the detection result.

Accordingly, in a case where the projection target position and the target moving object position determined as being optimal have changed during moving of the moving object 10, the projection target position and the target moving object position can be flexibly updated. Examples of a case where the projection target position and the target moving object position determined as being optimal have changed during moving of the moving object 10 include a case where the optimal projection target position has changed because circumstances (for example, the state of the projection surface) that could not be determined because of the long distance have been determined during moving of the moving object 10, and a case where the state of the projection destination object has changed during moving of the moving object 10.

Accordingly, the projection quality can be improved by performing the projection to a more favorable projection target position from a more favorable target moving object position, or the time required for starting the projection can be reduced by moving to the optimal target moving object position in a short time. That is, more favorable projection can be performed.

### >Case Where First Target Corresponds to Person or Like and Projection Destination Object<

In addition, the first target may include both of a person (or an automobile or the like in which the person is riding) and the projection destination object which is a candidate of the projection target position. In this case, the control device 14 acquires detection results (first target information) of states of the person and the projection destination object (first target), determines the projection target position and the target moving object position based on the detection results, moves the moving object 10 to the target moving object position, and performs the projection to the projection target position from the projection apparatus 11. Even during moving of the moving object 10 to the target moving object position, the control device 14 acquires the detection results (second target information) of the states of the person and the projection destination object and updates the projection target position and the target moving object position based on the detection results.

### <Method of Determining Projection Target Position>

The control device 14 may change a method of determining the projection target position based on the state (first target information) of the first target, based on the distance between the moving object 10 and the target moving object position. For example, the control device 14 determines the projection target position based on a position of the person 1 detected from the imaging result of the imaging apparatus 12 and on a direction of the person 1 detected from the imaging result of the imaging apparatus 12.

Specifically, for each of the projection candidate positions to which the projection can be performed, the control device 14 calculates an overall evaluation value using an expression “α×first evaluation value+β×second evaluation value” based on a first evaluation value of easiness of the observation calculated from the detected position of the person 1 and on a second evaluation value of easiness of the observation calculated from the detected direction of the person 1 and determines the projection candidate position of which the calculated overall evaluation value is the highest as the projection target position.

In this case, the control device 14, for example, calculates the overall evaluation value by setting coefficients α and β satisfying α>β in a case where the distance between the moving object 10 and the target moving object position is greater than or equal to a predetermined distance, and calculates the overall evaluation value by setting the coefficients α and β satisfying α<β in a case where the distance between the moving object 10 and the target moving object position is less than the predetermined distance. Alternatively, the control device 14 may calculate the overall evaluation value by setting β to a first value in a case where the distance between the moving object 10 and the target moving object position is greater than or equal to the predetermined distance, and calculate the overall evaluation value by setting β to a second value in a case where the distance between the moving object 10 and the target moving object position is less than the predetermined distance. A relationship “first value<second value” is established.

Accordingly, the projection target position can be determined by prioritizing the position of the person 1 over the direction of the person 1 in a stage where the moving object 10 and the target moving object position are far from each other, and the projection target position can be determined by prioritizing the direction of the person 1 over the position of the person 1 in a stage where the moving object 10 and the target moving object position are close to each other. That is, in a stage where the moving object 10 and the target moving object position are far from each other and it is difficult to determine a specific circumstance such as the direction of the person 1, the projection target position can be determined by prioritizing the position of the person 1, and the moving object 10 can be moved to approach the person 1. In a stage where the moving object 10 and the target moving object position are close to each other and it is easy to determine a specific circumstance such as the direction of the person 1, the projection target position can be determined by taking the direction of the person 1 into consideration, and the projection target position that is more easily observed by the person 1 can be determined.

<Update of Projection Target Position and Target Moving Object Position Based on Instruction Information from Outside>

A configuration in which the control device 14 mounted on the moving object 10 determines the projection target position and the target moving object position has been described. However, in this configuration, in a case where instruction information for providing an instruction for at least any of the projection target position or the target moving object position is received from an apparatus outside the moving object 10 during moving of the moving object 10 to the target moving object position, the control device 14 may update the projection target position and the target moving object position based on the instruction information.

### <Modification Example of Moving Object 10>

While a configuration in which the moving object 10 is a multicopter has been described, the moving object 10 may be an aircraft (flying object) other than a multicopter. In addition, the moving object 10 is not limited to a flying object and may be a vehicle, a robot, or the like that travels or walks on the ground.

### <Modification Example of Update Target>

While a configuration in which the control device 14 updates the projection target position and the target moving object position has been described, the control device 14 may be configured to update any of the projection target position and the target moving object position. For example, during moving of the moving object 10 to the target moving object position, the control device 14 acquires the detection result (second target information) of the state of the person 1 and updates the projection target position based on the detection result. Accordingly, in a case where the projection target position determined as being optimal has changed during moving of the moving object 10, the projection target position can be flexibly updated. Accordingly, the projection quality can be improved by performing the projection to a more favorable projection target position. That is, more favorable projection can be performed.

Alternatively, during moving of the moving object 10 to the target moving object position, the control device 14 acquires the detection result (second target information) of the state of the person 1 and updates the target moving object position based on the detection result. Accordingly, in a case where the target moving object position determined as being optimal has changed during moving of the moving object 10, the target moving object position can be flexibly updated. Accordingly, the projection quality can be improved by performing the projection from a more favorable target moving object position. That is, more favorable projection can be performed.

### <Other Application Examples of Control Device>

While a case where the control device according to the embodiment of the present invention is applied to the control device 14 of the moving object 10 has been described, the present invention is not limited to this configuration.

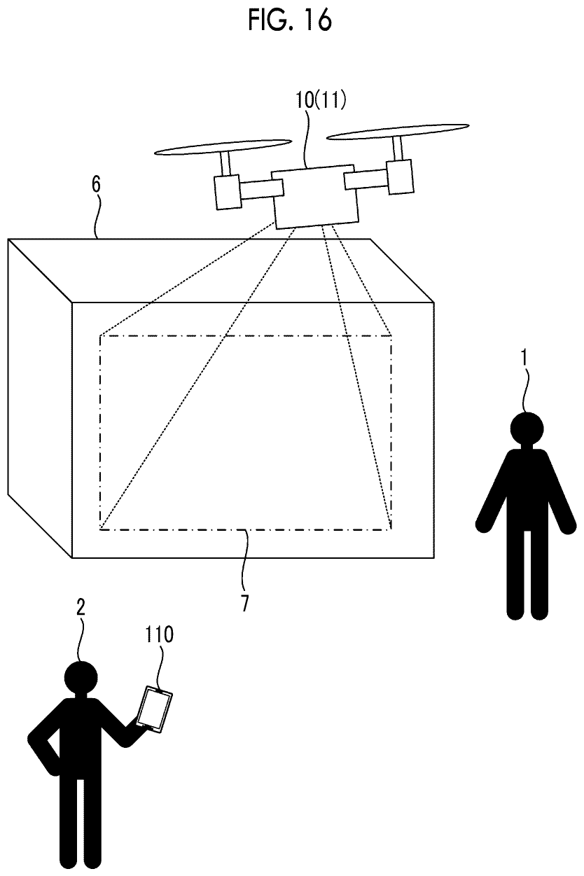

FIG. 16 is a diagram illustrating an example of an information terminal 110 to which the control device according to the embodiment of the present invention is applied. The control device according to the embodiment of the present invention may be applied to the information terminal 110.

The information terminal 110 is an information terminal that can directly or indirectly communicate with the moving object 10. Communication between the information terminal 110 and the moving object 10 is, for example, wireless communication. The information terminal 110 executes the various controls of the control device 14 by communicating with the moving object 10. In the example in FIG. 16, the information terminal 110 is a smartphone carried by an operator 2. However, the information terminal 110 can be various information terminals such as a desktop personal computer, a laptop personal computer, and a tablet terminal.

For example, the information terminal 110 receives the captured image of the imaging apparatus 12 from the moving object 10, acquires the detection result (first target information) of the state of the person 1 (first target) using the image recognition processing based on the received captured image, and determines the projection target position and the target moving object position based on the detection result. The information terminal 110 performs the controls of moving the moving object 10 to the target moving object position and performing the projection to the projection target position from the projection apparatus 11 by communicating with the moving object 10.

In addition, even during moving of the moving object 10 to the target moving object position, the information terminal 110 acquires the detection result (second target information) of the state of the person 1 based on the captured image received from the moving object 10 and updates the projection target position and the target moving object position based on the detection result. The information terminal 110 sets the updated projection target position and the updated target moving object position in the moving object 10 by communicating with the moving object 10. Accordingly, more favorable projection can be performed as in the configuration in which the control device according to the embodiment of the present invention is applied to the moving object 10.

The moving object 10 may be configured to acquire the detection result of the state of the person 1 obtained using the image recognition processing based on the captured image of the imaging apparatus 12, and the information terminal 110 may be configured to receive the detection result from the moving object 10.

### <Hardware Configuration of Information Terminal 110>

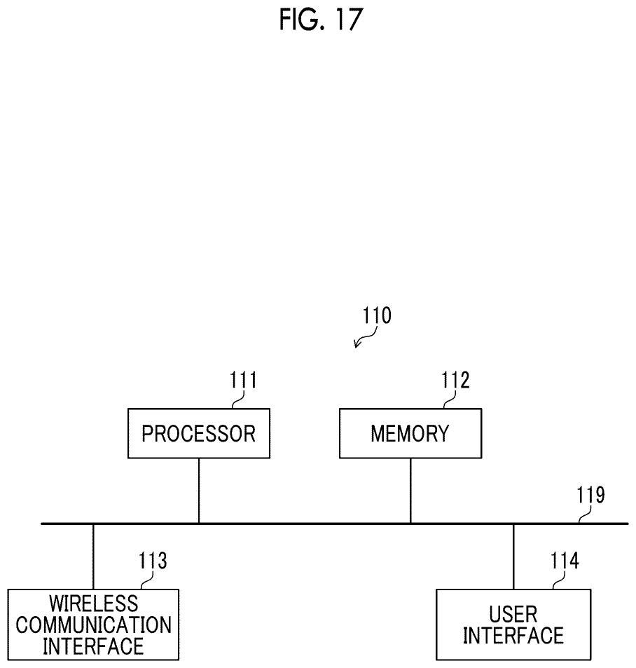

FIG. 17 is a diagram illustrating an example of a hardware configuration of the information terminal 110. The information terminal 110 illustrated in FIG. 16 can be implemented by, for example, the information terminal 110 illustrated in FIG. 17. The information terminal 110 comprises a processor 111, a memory 112, a wireless communication interface 113, and a user interface 114. The processor 111, the memory 112, the wireless communication interface 113, and the user interface 114 are connected to each other through, for example, a bus 119.

The processor 111 is a circuit that performs signal processing and is, for example, a CPU that controls the entire information terminal 110. The processor 111 may be implemented by other digital circuits such as an FPGA and a digital signal processor (DSP). In addition, the processor 111 may be implemented by combining a plurality of digital circuits with each other.

The memory 112 includes, for example, a main memory and an auxiliary memory. The main memory is, for example, a random access memory (RAM). The main memory is used as a work area of the processor 111.

The auxiliary memory is, for example, a non-volatile memory such as a magnetic disk, an optical disc, or a flash memory. The auxiliary memory stores various programs for operating the information terminal 110. The programs stored in the auxiliary memory are loaded into the main memory and executed by the processor 111.

In addition, the auxiliary memory may include a portable memory that can be detached from the information terminal 110. Examples of the portable memory include a memory card such as a universal serial bus (USB) flash drive or a secure digital (SD) memory card, and an external hard disk drive.

The wireless communication interface 113 is a communication interface for performing wireless communication with an apparatus (for example, the moving object 10) outside the information terminal 110. The wireless communication interface 113 is controlled by the processor 111.

The user interface 114 includes, for example, an input device that receives an operation input from a user, and an output device that outputs information to the user. The input device can be implemented by, for example, a pointing device (for example, a mouse), a key (for example, a keyboard), or a remote controller. The output device can be implemented by, for example, a display or a speaker. In addition, the input device and the output device may be implemented by a touch panel or the like. The user interface 114 is controlled by the processor 11.

### <Processing Based on Reliability Degree of Target Information>

The control device 14 may calculate a reliability degree of acquired target information (the first target information or the second target information) indicating the state of the first target and update the projection target position and the target moving object position by excluding the target information having a low reliability degree. For example, in a case where the reliability degree of the acquired target information is less than a threshold value, the control device 14 maintains the projection target position and the target moving object position based on the most recent target information of which the reliability degree is greater than or equal to the threshold value.

### <Update of Projection Target Position and Like Based on Plurality of Parameters>

A case where the position of the eye (the direction of the visual line) of the person 1, the direction of the body of the person 1, or the like is acquired as the target information in a case where the first target is a person has been described. However, in this case, the control device 14 may not update the projection target position and the target moving object position in a case where the position of the person 1 or the direction of the body of the person 1 has not changed even after a change in the visual line of the person 1. That is, in a case where a plurality of parameters such as the position of the person 1, the position of the eye of the person 1, the direction of the body of the person 1, the moving state (the speed and the direction) of the person 1, and the number of persons 1 are included in the target information, the control device 14 may update the projection target position and the target moving object position based on a combination of the plurality of parameters.

<Update of Projection Target Position and Like by Taking Interference with Projection of Other Projection Apparatuses into Consideration>

The first target may include other projection apparatuses different from the projection apparatus 11 mounted on the moving object 10. In this case, the control device 14 may detect projection states of the other projection apparatuses and determine and update the projection target position and the target moving object position suitable for the projection of the projection apparatus 11 by taking interference with projection of the other projection apparatuses into consideration.

<Update of Projection Target Position and Like Based on Difference between First Target Information and Second Target Information>

The control device 14 may update the projection target position and the target moving object position based on a difference between the first target information initially used for determining the projection target position and the target moving object position and the second target information acquired after moving of the moving object 10 to the target moving object position is started. For example, in a case where the difference between the first target information and the second target information does not satisfy a predetermined condition, the control device 14 may not update the projection target position and the target moving object position.

The predetermined condition is, for example, a condition that a difference between the state of the first target indicated by the first target information and the state of the first target indicated by the second target information is greater than or equal to a predetermined value. In a case where the first target is the person 1, the state of the first target is, for example, at least any of the position of the person 1, the position of the eye of the person 1, the direction of the body of the person 1, the moving state (the speed and the direction) of the person 1, or the number of persons 1.

<Control Based on Instruction to Stop Moving from Outside>

In a case where instruction information for providing an instruction to stop moving the moving object 10 is received from an apparatus outside the moving object 10 during moving of the moving object 10 to the target moving object position, the control device 14 may stop moving the moving object 10 based on the instruction information.

At least the following matters are described in the present specification.

### 1

A control device that controls a moving object on which a projection apparatus is mounted, the control device comprising a processor, in which the processor is configured to acquire first target information related to a state of a first target, determine a projection target position and a target moving object position based on the first target information, move the moving object to the target moving object position, perform projection to the projection target position from the projection apparatus, and during moving of the moving object to the target moving object position, acquire second target information related to the state of the first target and update the projection target position and/or the target moving object position based on the second target information.

### 2

The control device according to (1), in which the first target information is information obtained by imaging the first target via the imaging apparatus.

### 3

The control device according to (2), in which the imaging apparatus is mounted on the moving object.

### 4

The control device according to (3), in which the imaging apparatus includes a first imaging apparatus mounted on the moving object and a second imaging apparatus not mounted on the moving object.

### 5

The control device according to any one of (1) to (4), in which the first target includes a person, and the first target information indicates at least any of a position of an eye of the person, a direction of a body of the person, a moving state of the person, or the number of persons.

### 6

The control device according to (5), in which the processor is configured to, in a case where information about a plurality of persons is acquired as the first target information, determine the projection target position based on at least any of positions of eyes of the plurality of persons, directions of bodies of the plurality of persons, a positional relationship among the plurality of persons, or moving states of the plurality of persons.

### 7

The control device according to any one of (1) to (6), in which the first target includes a projection destination object that is a candidate of the projection target position.

### 8

The control device according to (7), in which the first target information includes projection surface information related to a state of a projection surface of the projection destination object.

### 9

The control device according to any one of (1) to (8), in which the processor is configured to stop updating the projection target position and/or the target moving object position in a case where the moving object has entered a predetermined region including the target moving object position.

### 10

The control device according to any one of (1) to (9), in which the processor is configured to update the projection target position and/or the target moving object position in a range corresponding to a distance between the moving object and the target moving object position.

### 11

The control device according to any one of (1) to (10), in which the processor is configured to change a method of determining the projection target position based on the first target information, based on a distance between the moving object and the target moving object position.

### 12

The control device according to any one of (1) to (11), in which the processor is configured to determine the projection target position by excluding a change in the first target information caused by the moving object.

### 13

The control device according to any one of (1) to (12), in which the processor is configured to, after the moving object moves to the target moving object position, acquire the second target information and update the projection target position and/or the target moving object position based on the second target information.

### 14

The control device according to any one of (1) to (13), in which the processor is configured to maintain the target moving object position in a case where the moving object is positioned in a predetermined region including the target moving object position and the projection target position is updated.

### 15

The control device according to any one of (1) to (14), in which the processor is configured to, in a case where instruction information for providing an instruction for at least any of the projection target position or the target moving object position is received, update the projection target position and/or the target moving object position based on the instruction information.

### 16

A control method performed by a processor of a control device that controls a moving object on which a projection apparatus is mounted, the control method comprising acquiring first target information related to a state of a first target, determining a projection target position and a target moving object position based on the first target information, moving the moving object to the target moving object position, performing projection to the projection target position from the projection apparatus, and acquiring, during moving of the moving object to the target moving object position, second target information related to the state of the first target and updating the projection target position and/or the target moving object position based on the second target information.

### 17

A control program for causing a processor of a control device that controls a moving object on which a projection apparatus is mounted, to execute a process comprising acquiring first target information related to a state of a first target, determining a projection target position and a target moving object position based on the first target information, moving the moving object to the target moving object position, performing projection to the projection target position from the projection apparatus, and acquiring, during moving of the moving object to the target moving object position, second target information related to the state of the first target and updating the projection target position and/or the target moving object position based on the second target information.

While various embodiments have been described above, the present invention is, of course, not limited to such examples. It is apparent that those skilled in the art may perceive various modification examples or correction examples within the scope disclosed in the claims, and those examples are also understood as falling within the technical scope of the present invention. In addition, constituents in the embodiments may be combined with each other in any manner without departing from the gist of the invention.

The present application is based on Japanese Patent Application (JP2021-212601) filed on Dec. 27, 2021, the content of which is incorporated in the present application by reference.

### EXPLANATION OF REFERENCES

1: person
2: operator
6: projection target object
6A: first projection target object
6B: second projection target object
7: projection destination region
10: moving object
11: projection apparatus
12, 12a: imaging apparatus
14: control device
14a: storage medium
15: communication unit
16: moving mechanism
31: light source
32: optical modulation unit
33: projection optical system
34: control circuit
110: information terminal
111: processor
112: memory
113: wireless communication interface
114: user interface
119: bus
e1: first update available area
p1: first position
e2: second update available area
p2: second position
P1: first position
E1: update stopping area
P2: second position

What is claimed is:

1. A control device that controls a moving object on which a projection apparatus is mounted, the control device comprising:
a processor,
wherein the processor is configured to:
acquire first target information related to a state of a first target;
determine a projection target position and a target moving object position based on the first target information;
move the moving object to the target moving object position;
perform projection to the projection target position from the projection apparatus; and
during moving of the moving object to the target moving object position, acquire second target information related to a state of the first target, update the projection target position based on the second target information and update the target moving object position based on the updated projection target position.

2. The control device according to claim 1,
wherein the first target information is information obtained by imaging the first target by the imaging apparatus.

3. The control device according to claim 2,
wherein the imaging apparatus is mounted on the moving object.

4. The control device according to claim 3,
wherein the imaging apparatus includes a first imaging apparatus mounted on the moving object and a second imaging apparatus not mounted on the moving object.

5. The control device according to claim 1,
wherein the first target includes at least one person, and
the first target information indicates at least one of a position of an eye of the person, a direction of a body of the at least one person, a moving state of the at least one person, or number of the at least one person.

6. The control device according to claim 5,
wherein the processor is configured to, in a case where information about a plurality of persons is acquired as the first target information, determine the projection target position based on at least one of positions of eyes of the plurality of persons, directions of bodies of the plurality of persons, a positional relationship among the plurality of persons, or moving states of the plurality of persons.

7. The control device according to claim 1,
wherein the first target includes a projection destination object that is a candidate of the projection target position.

8. The control device according to claim 7,
wherein the first target information includes projection surface information related to a state of a projection surface of the projection destination object.

9. The control device according to claim 1,
wherein the processor is configured to stop the updating of at least one of the projection target position or the target moving object position in a case where the moving object has entered a predetermined region including the target moving object position.

10. The control device according to claim 1,
wherein the processor is configured to update the projection target position in a range corresponding to a distance between the moving object and the target moving object position, and update the target moving object position based on the updated projection target position.

11. The control device according to claim 1,
wherein the processor is configured to change a method of determining the projection target position based on the first target information, based on a distance between the moving object and the target moving object position.

12. The control device according to claim 1,
wherein the processor is configured to determine the projection target position by excluding a change in the first target information caused by the moving object.

13. The control device according to claim 1,
wherein the processor is configured to, after the moving object moves to the target moving object position, acquire the second target information, update the projection target position based on the second target information and update the target moving object position based on the updated projection target position.

14. The control device according to claim 1,
wherein the processor is configured to maintain the target moving object position in a case where the moving object is positioned in a predetermined region including the target moving object position and the projection target position is updated.

15. The control device according to claim 1,
wherein the processor is configured to, in a case where instruction information for providing an instruction for at least one of the projection target position or the target moving object position is received, update the projection target position based on the instruction information and update the target moving object position based on the updated projection target position.

16. A control method performed by a processor of a control device that controls a moving object on which a projection apparatus is mounted, the control method comprising:
acquiring first target information related to a state of a first target;
determining a projection target position and a target moving object position based on the first target information;
moving the moving object to the target moving object position;
performing projection to the projection target position from the projection apparatus; and
acquiring, during moving of the moving object to the target moving object position, second target information related to a state of the first target, updating the projection target position based on the second target information and updating the target moving object position based on the updated projection target position.

17. A non-transitory computer readable medium storing a control program for causing a processor of a control device that controls a moving object on which a projection apparatus is mounted, to execute a process comprising:
acquiring first target information related to a state of a first target;
determining a projection target position and a target moving object position based on the first target information;
moving the moving object to the target moving object position;
performing projection to the projection target position from the projection apparatus; and
acquiring, during moving of the moving object to the target moving object position, second target information related to a state of the first target, updating the projection target position based on the second target information and updating the target moving object position based on the updated projection target position.
